(19) United States
(12) Patent Application Publication
(10) Pub. No.: US 2006/0146569 A1
(43) Pub. Date: Jul. 6, 2006

(54) Backlight module with filler portion

(75) Inventors: Po-Shan Huang, Miao-Li (TW); Shuai Guo, Shenzhen (CN); Ya-Dan Liang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,177

(22) Filed: Dec. 23, 2005

(30) Foreign Application Priority Data
Dec. 31, 2004 (TW) 93141617

(51) Int. Cl. F21V 7/04

(52) U.S. Cl. 362/612; 362/613; 362/621

(57) ABSTRACT

A backlight module (3) includes a light guide plate (31) having an incident surface (311), and a plurality of light sources (32) disposed opposite to the incident surface. Each of the light sources defines an encapsulation portion (321) to cover and protect core parts of the light source. A filler portion (33) is provided between the light source and the incident surface. A refractive index of the filler portion is the same as refractive indexes of the encapsulation portions and the light guide plate. Therefore a transmission rate of light beams from each light source to the light guide plate approaches or even is 1. Thus the transmission rate of the backlight module is correspondingly high. The arrangement of the filler portion between the light guide plate and the light sources decreases or even eliminates loss of light beams. Therefore the utilization of light beams and the brightness of the backlight module are improved.

### FIELD OF THE INVENTION

The present invention relates to backlight modules used in devices such as liquid crystal displays (LCDs), and especially to a backlight module highly efficient in the utilization of light beams.

### GENERAL BACKGROUND

Conventionally, a liquid crystal display (LCD) device includes a backlight module and a liquid crystal panel. The backlight module is an important element for transmitting and providing light beams to the liquid crystal panel, so that the liquid crystal panel can display images.

FIG. 3 shows a schematic, isometric view of a conventional backlight module 1. The backlight module 1 includes a light guide plate 11 and a plurality of light sources 12. The light guide plate 11 includes an incident surface 111, an emitting surface 112, and a bottom surface 113 opposite to the emitting surface 112. The light sources 12 are point light sources such as light emitting diodes (LEDs), and are disposed opposite to the incident surface 111. Each light source 12 includes an encapsulation portion 121 that covers and protects core parts of the light source 12. The encapsulation portion 121 is made from transparent resin materials.

However, the backlight module 1 has the following problems.

The refractive indexes of each encapsulation portion 121, the light guide plate 11, and the air between the encapsulation portion 121 and the light guide plate 11 are all different from one another. Therefore light beams emitted from each light source 12 may be reflected twice. The first reflection may occur at the interface between the encapsulation portion 121 and the air, and the second reflection may occur at the interface between the air and the incident surface 111. The reflections cause loss of light beams. Thus the utilization of light beams and the brightness of the backlight module 1 may be unsatisfactory.

What is needed, therefore, is a backlight module that overcomes the above-described deficiencies.

### SUMMARY

In a preferred embodiment, a backlight module includes a light guide plate having an incident surface, and a plurality of light sources disposed opposite to the incident surface. Each light source defines an encapsulation portion to cover and protect core parts of the light source. A filler portion is provided between the light source and the incident surface.

A refractive index of the filler portion is the same as refractive indexes of the encapsulation portions and the light guide plate. Therefore a transmission rate of light beams from each light source to the light guide plate approaches or even is 1. Thus the transmission rate of the backlight module is correspondingly high. The arrangement of the filler portion between the light guide plate and the light sources decreases or even eliminates loss of light beams. Therefore the utilization of light beams and the brightness of the backlight module are improved.

Other advantages and novel features will become more apparent from the following detailed description when taken in conjunction with the accompanying drawings.

### BRIEF DESCRIPTION OF THE DRAWINGS

FIG. 1 is an isometric view of a backlight module according to a preferred embodiment of the present invention.

FIG. 2 is a top view of the backlight module of FIG. 1, showing light sources thereof in dashed lines.

FIG. 3 is an isometric view of a conventional backlight module.

### DETAILED DESCRIPTION OF PREFERRED EMBODIMENTS

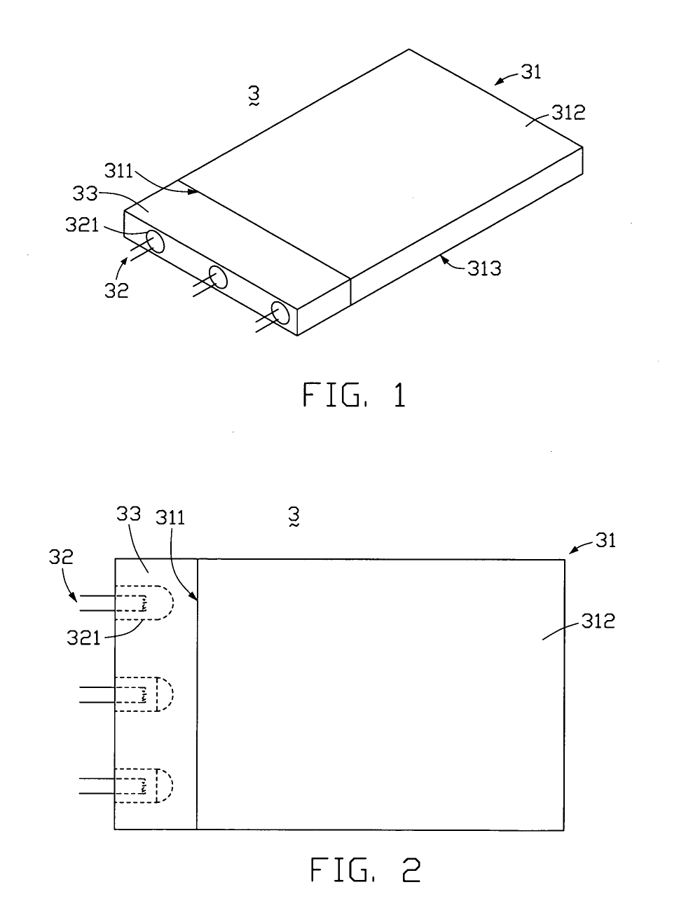

FIG. 1 is an isometric view of a backlight module according to a preferred embodiment of the present invention. The backlight module 3 includes a light guide plate 31 and a plurality of light sources 32. The light guide plate 31 is in the form of a flat sheet. The light guide plate 31 includes an incident surface 311, an emitting surface 312, and a bottom surface 313 opposite to the emitting surface 312. The light sources 32 are point light sources, such as light emitting diodes (LEDs), and are disposed opposite to the incident surface 311. Each light source 32 includes an encapsulation portion 321 that covers and protects core parts of the light source 32. The encapsulation portion 321 is made from transparent resin materials. The light guide plate 31 is typically made of polyethylene terephthalate (PET), polycarbonate (PC), or polymethyl methacrylate (PMMA).

A filler portion 33 is provided between the light sources 32 and the incident surface 311. The filler portion 33 is made from transparent resin materials. A refractive index of the filler portion 33 is the same as or greater than refractive indexes of the encapsulation portions 321 and the light guide plate 31.

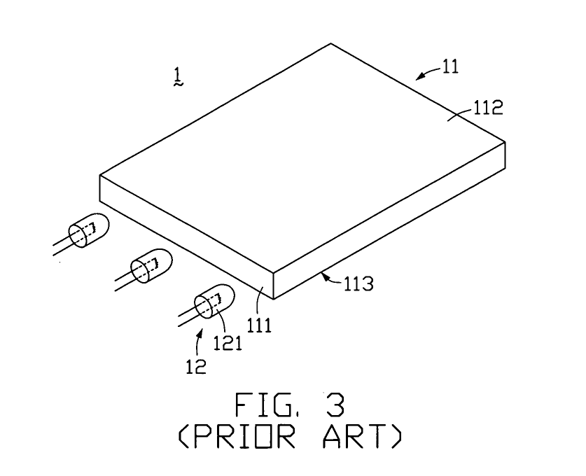

Referring to FIG. 2, light beams emitted from each light source 32 may be liable to reflect twice before entering the light guide plate 31. The first reflection may occur at the interface between the encapsulation portion 321 and the filler portion 33, and the second reflection may occur at the interface between the filler portion 33 and the incident surface 311.

Simulation data is shown in the following table:

| n₁ | n₂ | n₃ | θ | L |
|---|---|---|---|---|
| 1.5 | 1 (air) | 1.5 | 0 | 0.9216 |
| 1.5 | 1.1 | 1.5 | 0 | 0.9532 |
| 1.5 | 1.2 | 1.5 | 0 | 0.9755 |
| 1.5 | 1.3 | 1.5 | 0 | 0.9898 |
| 1.5 | 1.4 | 1.5 | 0 | 0.9976 |
| 1.5 | 1.5 | 1.5 | 0 | 1 |
| 1.5 | 1 (air) | 1.5 | 41.81 | 0.0004 |
| 1.5 | 1.1 | 1.5 | 41.81 | 0.816 |
| 1.5 | 1.2 | 1.5 | 41.81 | 0.9345 |
| 1.5 | 1.3 | 1.5 | 41.81 | 0.9783 |
| 1.5 | 1.4 | 1.5 | 41.81 | 0.9957 |
| 1.5 | 1.5 | 1.5 | 41.81 | 1 |

In the table, n₁ represents the refractive index of the encapsulation portion 321, n₂ represents the refractive index of the filler portion 33, and n₃ represents the refractive index of the light guide plate 31. θ represents an angle of incidence, and L represents a transmission rate of light beams from the light source 32 to the light guide plate 31.

In the above table, it is apparent that when the refractive indexes are all the same, i.e., when n₁=n₂=n₃, the transmission rate L is 1, and the transmission rate of the backlight module 3 is correspondingly high. However, when the refractive index of n₂ corresponds to that of air, n₂ is less than both n₁ and n₃, and the transmission rate L is less than 1. The arrangement of using the filler portion 33 to replace air between the light guide plate 31 and the light source 32 decreases or even eliminates loss of light beams. Therefore the utilization of light beams and the brightness of the backlight module 3 are improved.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a light guide plate having an incident surface;
a plurality of light sources disposed opposite to the incident surface, wherein each light source defines an encapsulation portion for covering and protecting one or more internal parts of the light source; and
a filler portion between the light sources and the incident surface.

2. The backlight module as claimed in claim 1, wherein the filler portion is made from transparent resin material.

3. The backlight module as claimed in claim 1, wherein a refractive index of the filler portion is the same as that of the encapsulation portion.

4. The backlight module as claimed in claim 3, wherein the refractive index of the filler portion is the same as that of the light guide plate.

5. The backlight module as claimed in claim 1, wherein a refractive index of the filler portion is greater than that of the light guide plate.

6. The backlight module as claimed in claim 1, wherein the light guide plate is in the form of a flat sheet.

7. The backlight module as claimed in claim 1, wherein the light guide plate is made from polyethylene terephthalate (PET), polycarbonate (PC), or (PC), or polymethyl methacrylate (PMMA).
